(19) United States
(12) Patent Application Publication
(10) Pub. No.: US 2014/0255645 A1
(43) Pub. Date: Sep. 11, 2014

(54) DIRECT TEXTURE PRINT PRODUCTION

(71) Applicant: FOXBOX ORIGINALS LLC, Denver, CO (US)

(72) Inventors: Jeff Shumaker, Denver, CO (US); John Greenwood, Denver, CO (US)

(73) Assignee: FOXBOX ORIGINALS LLC, Denver, CO (US)

(21) Appl. No.: 14/199,518

(22) Filed: Mar. 6, 2014

Related U.S. Application Data
(60) Provisional application No. 61/774,411, filed on Mar. 7, 2013.

(51) Int. Cl. B05D 5/06; B44F 11/02; B05C 9/02

(52) U.S. Cl. CPC B05D 5/06; B05C 9/022; B44F 11/02
USPC 428/99; 118/697; 427/280; 427/262; 428/211.1

(57) ABSTRACT

Systems and methods for allowing a user to create a texture on a substrate while printing in line with inks are disclosed. An image of a desired texture may be provided, and the contrast levels may be adjusted to make the dark areas very dark and the light areas very light. The adjusted image of the texture may be provided to a press as one or more texture image layers. A color image layer may also be provided to the press. The press may print the texture image layers on the substrate first, allowing the ink to build up to create the texture. The final color image layer may then be printed on top of the texture image layers. The printed substrate may be folded to create a final image product, such as a gallery wrap for hanging on a wall.

### FIELD OF THE INVENTION

The present invention is directed to a system and methods for printing to create an image with texture, and more specifically to a system and methods of creating texture on a substrate while printing in line at the time of print production.

### BACKGROUND

There are many different printing systems and printing styles allowing for users to create images for display. These may range from individual pieces of artwork for display in a home, to outdoor banners and billboards. The quality of the final print may depend on the underlying substrate printed upon, as well as the type of printing process used. For example, printing on a relatively expensive stretched canvas may provide a high quality final print, while printing on normal copy paper creates a final print of lower quality. Existing printing techniques include applying a solvent print on canvas, film applied to canvas, photographic reproductions on textured papers, and using embossing techniques on finished prints. However, to create quality print pieces, these printing techniques require either expensive substrates or expensive printing processes.

In addition to creating the printed image, the prior art methods of mounting and displaying printed images also require expensive materials and mounting techniques. For example, canvas prints may have to be mounted onto hardboard or wrapped around a wooden frame before they can be displayed. When a print is made on high-gloss or embossed paper, this paper still has to be wrapped around a wooden frame and secured with tape or glue.

Currently, it is possible to print onto a smooth piece of cardboard, which can then be folded to form the desired box shape for display of the print. However, existing techniques only print flat images onto the smooth cardboard, and do not provide the underlying texture that is present when a more expensive material such as canvas is printed upon.

What is needed is a system and method to print upon a less expensive substrate using an inexpensive technique that provides texture to the final image produced.

### SUMMARY OF THE INVENTION

The systems and methods described herein are directed to a printing process and system allowing a user to create a texture with inks, and further to allowing a user to create an image with texture on a substrate while printing in line.

The process for creation of a texture with inks may start with providing a digital image of the texture. This digital image may be provided to a computer system including a processor for executing computer programs stored on computer readable media, display screen, memory, and user interface. The user interface may be a touch screen, mouse, touch pad, or any other device that allows a user to interact with programs executed by the computer and displayed on the display screen. The digital image of the texture may be previously stored on the computer, may be selected from images accessed from the internet or other network over a network connection, or it may be uploaded to the computer by the user. The digital image of the texture may be a photographic image of the desired texture. The digital image may then be imported into an image editing program, such as Adobe Photoshop™. The image editing program is used to adjust the image based on light areas and dark areas, wherein the lightest areas are made very light and the darkest areas are made very dark. This may be done by using contrast curves or level controls.

After the image has been adjusted in the image editing program, the edited image may be saved. The saved image file is then ripped to a press. A raster image processor is used to convert the saved image to a rastered image, which is then sent to the printer. The rastered image may be designated according to the different layers of the image to be printed. For example, there may be two white layers, which may be used to build the texture, and one color layer applied onto the white texture layers. Alternatively, there may be one white layer and one color layer used to build texture, or only color layers used to both build texture and print the final image. Each of these layers may be created as an individually saved image, and ripped and sent to the press. Alternatively, the press may contain memory which stores texture layers thereon. In this situation, only the final color image needs to be ripped and transmitted. The printer then retrieves the first two texture layers from its memory, and prints those along with the sent color image in the in line printing pass. When using three layers, three windows may appear on the user interface (either on the computer system or the printer) corresponding to each image layer, and the user may use the windows presented to select the order in which the layers will be laid down.

A substrate is loaded into the printer, and the printer lays down the various layers of the rastered image. The press may be any printer that allows for printing multiple layers. Preferably, the printer may be able to use a white ink head. When printing, the printer may lay down the white layers first. In laying down the white layers, the darkest areas of the image receive the most ink. The ink builds up and forms the high area of the texture being created for the image. However, this process can be used to build texture with underlying color layers or clear layers if white ink is not available. The amount of ink applied in any given area corresponds to the dot percentage in the image separation of the saved corrected image ripped to the press. The dot percentage is based on the contrast level in the digital image. There is a high percentage of ink applied in the dark areas of the corrected image, and a low percentage of ink applied in the light areas. As the carriage head passes, the color heads (cyan, magenta, yellow, and black) lay down the colors on top of the white ink. This color ink layer conforms to the texture that has been achieved through the application of the white ink. As mentioned above, color ink or clear ink may be used to build the texture layer instead of white ink.

After the color ink has been laid down, the substrate may be removed from the printer. According to some embodiments, the substrate may contain pre-formed folds or lines indicating where the substrate could be folded. In these embodiments, folding the substrate along the folds or lines transforms the substrate into a form that mimics a canvas print, gallery wrap, or other three dimensional shape.

According to some embodiments, the substrate may be formed of a corrugated box material, such as cardboard. In other embodiments, the substrate may be paper, pressure sensitive vinyl, or any other material capable of being printed upon. The substrate may be smooth or have some texture included on it before printing. In some embodiments, the substrate may have an image already formed thereon, and the system and methods described herein may be used to add further texture or images, or to embellish certain aspects of the image already on the substrate.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an example of a digital image, made from a photograph of canvas material, that may be used as the beginning digital image of a texture.

FIG. 2 is an example of an original digital image of a texture that may be input into an image editing program.

FIG. 3 is an example of an edited digital image created in an imaging editing program by adjusting the contrast so that the dark areas are made very dark and the light areas are made very light.

FIG. 4 is an example of a raster image sent to the press to be printed on the substrate, including first, second and third layers of ink.

FIG. 5 is an example of the substrate with the first two layers laid down to form the areas of texture.

FIG. 6 is an example of the color layer of ink laid down on top of the texture ink layers on the substrate.

FIG. 7 is an example of a first, white ink layer of an image product.

FIG. 8 is an example of a second, color texture layer of an image product.

FIG. 9 is an example of a third, color ink layer of an image product.

FIG. 10 is an example of a substrate in the process of having the three ink layers laid down to form the final image product.

FIG. 11 is an example of a potential layout of a substrate with pre-formed folds or fold lines used to create a final image product.

FIG. 12 is an example of a substrate with pre-formed folds or fold lines after printing the image thereon.

FIG. 13 is an example of the substrate of FIG. 12 after folding the substrate to form a final image product in the form of a gallery-wrap art piece.

FIG. 14 is an example of a final image product using a cardboard substrate.

FIG. 15 is an example of the back of a final image product using a cardboard substrate.

### DETAILED DESCRIPTION OF THE INVENTION

The system and methods allow for an image, including texture, to be created on a flat substrate material while printing in line with a press. The press may be a color press where color images are desired, or it may be a black and white press. The texture produced by the inks may form a background texture for the entire image, or may be applied to certain parts of an image to add relief or draw attention to a portion of the printed piece. For example, an underlying texture mimicking more expensive printed canvas may be created using layers of white ink, with the color ink image being printed on top of the white ink texture layers. This allows for consumers to create images for display that closely resemble more expensive image products printed directly on canvas, without incurring the additional expenses of actually printing on canvas material. In addition to canvas, other underlying materials or styles may be mimicked such as burlap, brush strokes, or secondary images or logos under a color image. The system and methods further allow for texture to be added to existing image prints to embellish the existing image. The additional texture added by printing the ink layers may be used to create a matte, semi-gloss, or other known finish style. Alternatively, the texture added may be placed to draw attention to or accent specific areas of the existing image.

The system and methods allow for a finished print created using a flat substrate and inks that mimic more expensive underlying materials, such as canvas. The flat substrate used may be an inexpensive carrier, such as paper, cardboard, or pressure sensitive vinyl. The system and method further allow users to create custom prints with any underlying texture applied, using only inexpensive substrates and inks.

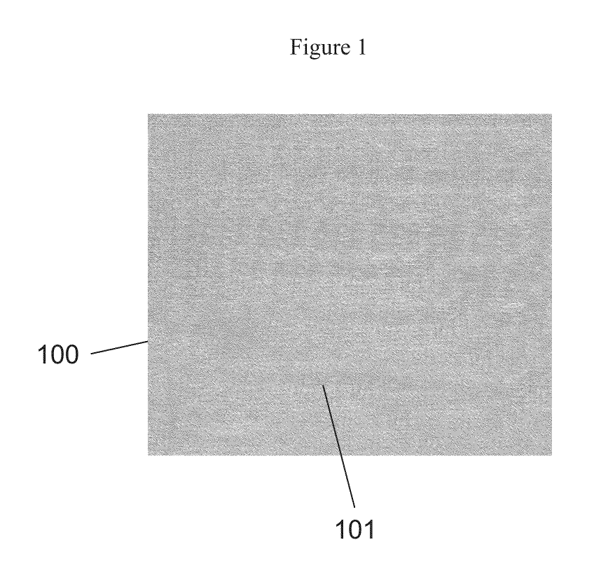

In one aspect, the present invention allows for the creation of a texture on a substrate while printing in line with white ink, color ink, black ink, or any combination thereof, wherein the ink printed on the substrate is built up in certain areas to create the texture. The process for creation of a texture with inks may start with providing a digital image of the texture. This digital image may be provided to a computer system including a processor for executing computer programs stored on computer readable media, display screen, memory, and user interface. The user interface may be a touch screen, mouse, touch pad, or any other device that allows a user to interact with programs executed by the computer. In some embodiments, the computer system may be part of a printer that ultimately prints the images on the substrate. The digital image of the texture may be previously stored on the computer, selected from images accessed from the internet or other network over a network connection, or uploaded to the computer by the user. The digital image may be a photographic image of the desired texture, and could be transferred from a digital camera to the computer system. For example, a user may photograph an article having the desired texture that they wish to mimic on the substrate. An example of a digital texture image 100 of canvas is shown in FIG. 1, wherein the texture 101 makes up the entire image 100. This canvas image 100 may be created by taking a photograph of a piece of canvas and uploading the photograph into the computer system. In other embodiments the texture 101 could make up only a portion of the image, or there could various types of texture included in the same image. For example, a digital image may include areas of brush stroke texture as well as a background texture of canvas.

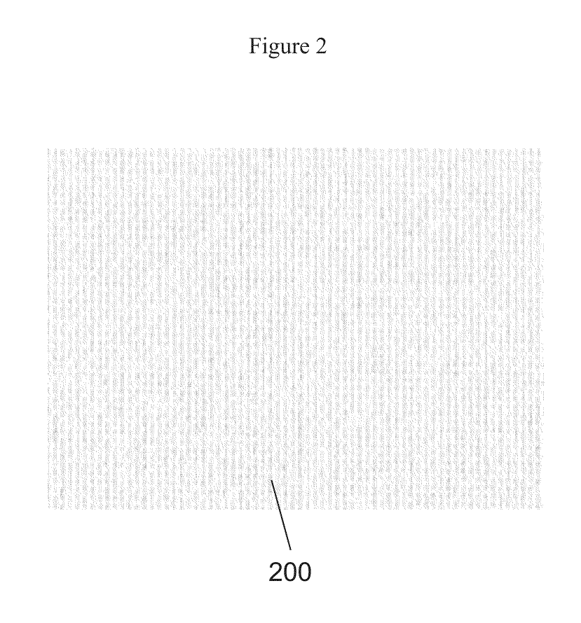

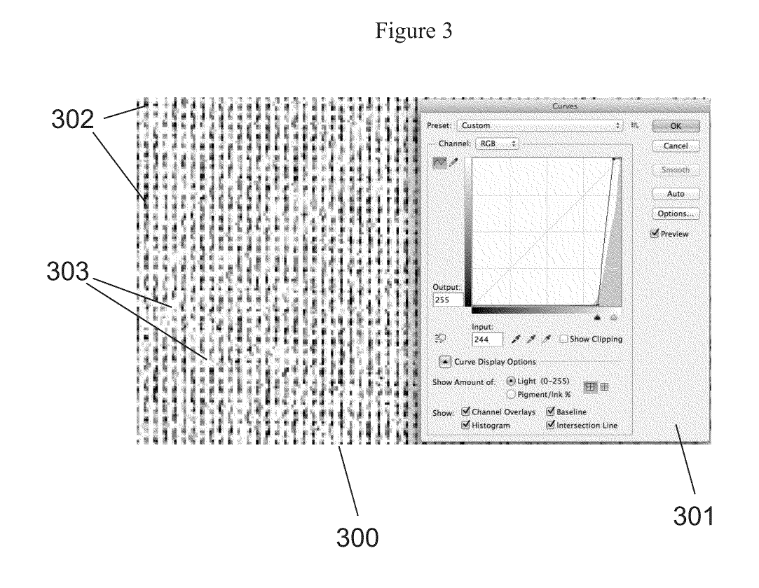

After the digital image is input into the computer system, it may then be imported into an image editing program, such as Adobe Photoshop™. The image editing program may display the digital texture image on the user interface, and may provide selectable options for the user to manipulate the properties of the image. The image editing program may allow the user to adjust contrast, brightness, size, color, sharpness, softness, saturation, tone, blur, or other features of the image. The image editing program may also contain image effects that may be applied to the digital image, including but not limited to artistic effects, shadowing, or transparency. The image editing program may be locally stored and executed by the computer system, or the image editing program may be accessed over a network such as the internet. The image editing program is used to adjust the image based on light areas and dark areas, wherein the lightest areas are made very light and the darkest areas are made very dark. This may be done by using contrast curves or level controls. FIG. 2 shows an example of the original digital image 200 first input into the image editing program. FIG. 3 shows the digital image 300 after the contrast has been changed using the image editing program 301. As seen in FIG. 3, the image editing program 301 may provide the user with the option to adjust the contrast curves of the digital image. By adjusting the contrast curves, the user may modify the digital image such that the dark areas 302 become very dark and the light areas 303 become very light. This produces a high-contrast, corrected image 300 as shown in FIG. 3. The corrected image 300 may also be created by adjusting contrast levels or brightness features within the image editing program 301.

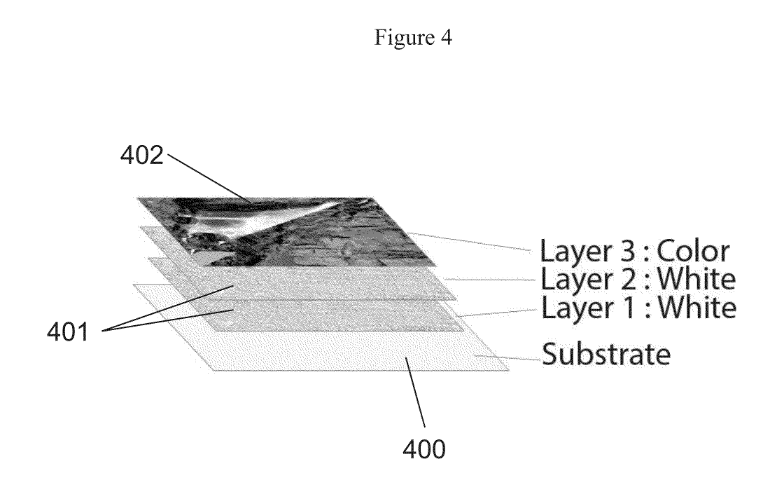

The corrected image is then saved, and a raster image process is used to rip the saved corrected image file to the press. The press may be a UV Inkjet printer such as a Vutek GS press, or other printer using UV ink. However, any printer and ink combination that allows for layers of ink to build up to create texture may be used. As shown in FIG. 4, the rastered image may be designated according to the different layers of the image to be printed onto a substrate 400. There may be two or more white layers 401, which may be used to build the texture, and one or more color layers 402 applied onto the white texture layers 401. Alternatively, the layers used to build the texture may also be color layers, or may be clear ink layers. The press may include white ink or clear ink options, allowing for up to three layers of printing in one pass through the press. In printing a color image, one or two of the layers may be white ink. Depending on the texture and final image desired, the number of texture layers and color layers may vary and any number of layers may be used.

Preferably, the ink used is UV ink which instantly cures under the UV light as it is applied. Additionally, the UV ink is not absorbed into the substrate, but rather sits on top of the substrate. This allows the layers to be built up to create more texture. In other embodiments, latex paint could be used for the different layers to create the texture and image layers.

The press system may be capable of laying down the texture layers prior to laying down the color, or final layer as the top image. The press system may include a computer processor and memory for storing data and executable programs enabling the printer to lay down specific layers of an image. Alternatively, the press system may be in communication with a separate computer system that sends instructions to the printer for laying down the specific layers of an image.

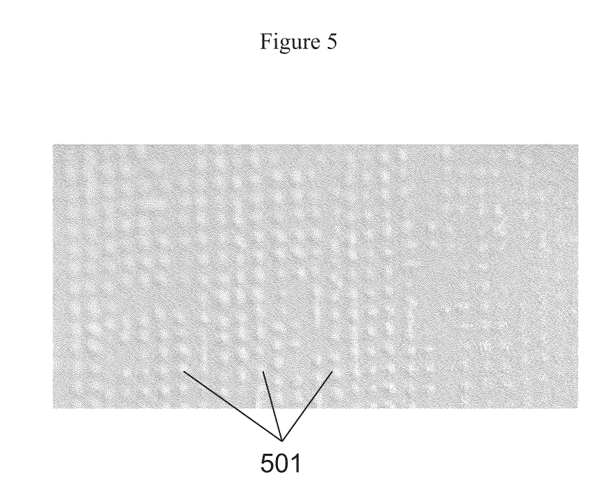

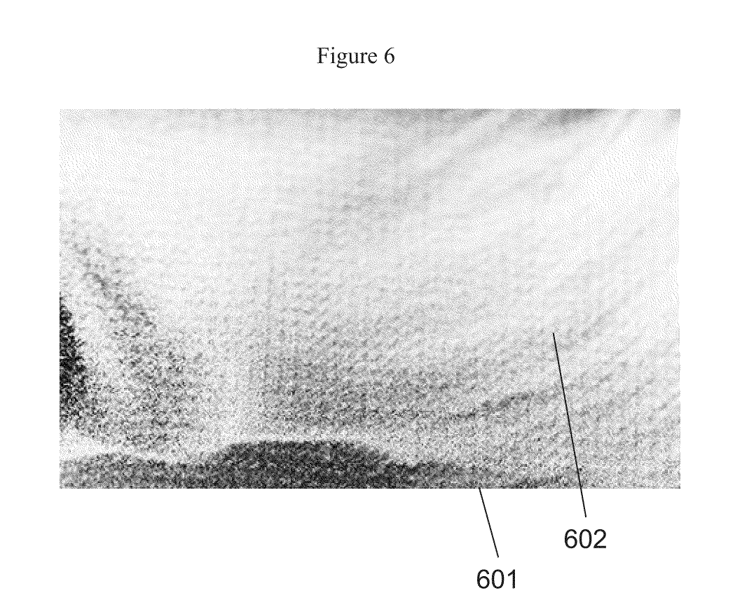

During the printing operation, a white ink head may lay down the white ink layers on the substrate first, with the darkest areas from the high-contrast corrected image receiving the most ink. The ink builds up in these areas, and forms the high areas of the desired texture. As shown in FIG. 5, for the canvas texture example these areas may appear as raised bumps 501 in a pattern mimicking the texture of an actual canvas substrate material. As the carriage head passes over the substrate during the printing operation, the color ink heads (which are typically cyan, magenta, yellow, and black ink heads) lay down the color ink on top of the white ink. Because the white ink been built up on the substrate in the form of the desired texture, the color ink laid down conforms to this desired texture. As shown in FIG. 6, a color ink layer 601 laid down on top of white ink layers shows the desired canvas texture 602 underlying the image. As seen in FIG. 6, the system and method can produce a color image printed on a flat substrate that has the appearance of being printed on a more expensive canvas material.

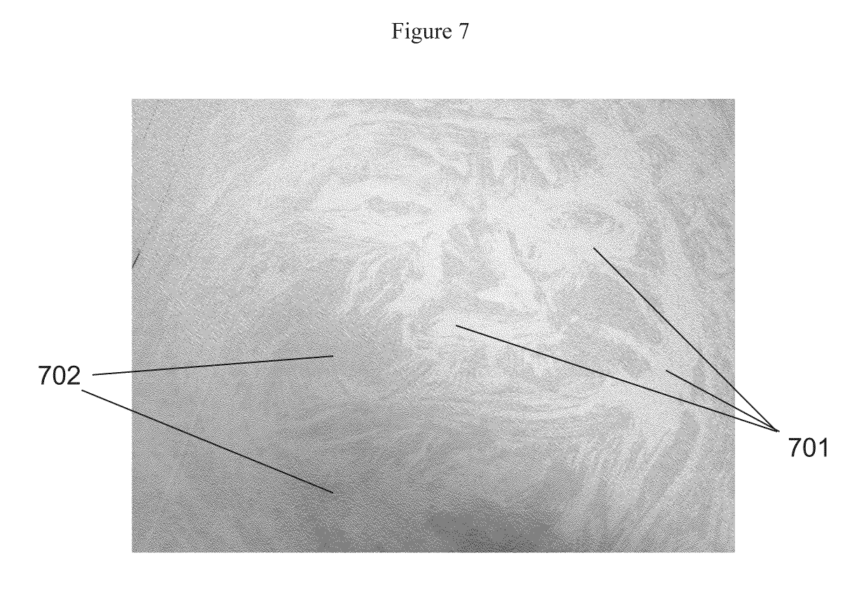

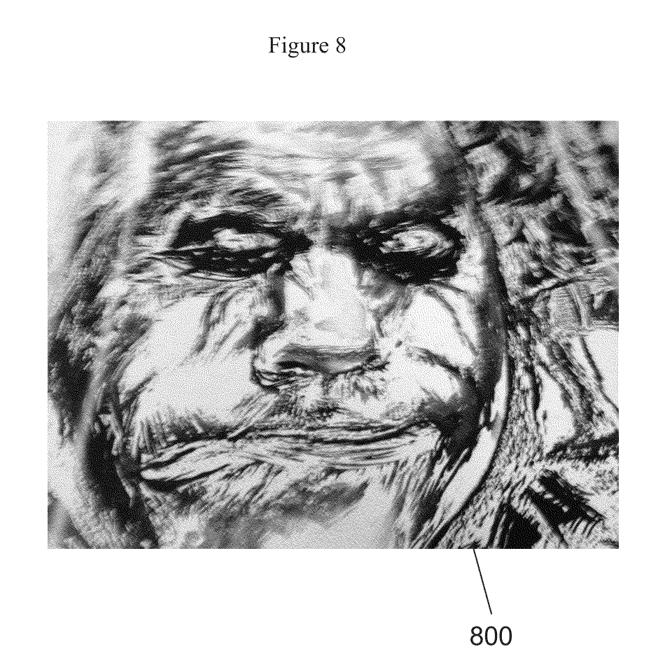

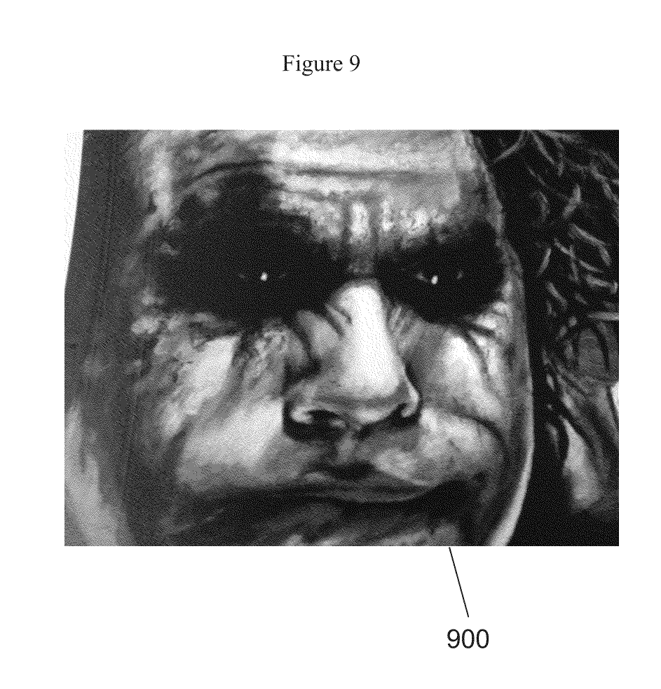

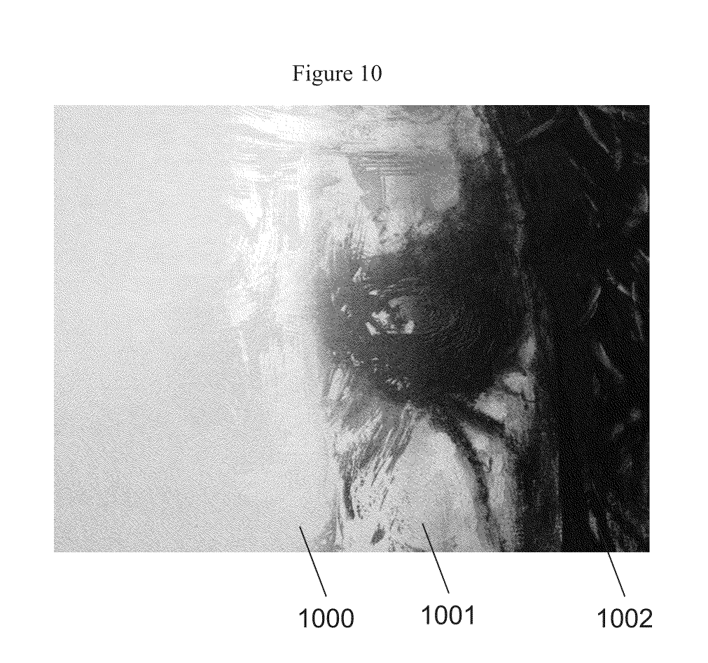

FIGS. 7-10 show an example of the various layers of ink laid down by the printer to create a final, textured image on a substrate. In the example shown in FIGS. 7-10, an image was uploaded to the printer, wherein the uploaded image contained a base layer designed with a texture to mimic brush strokes of an actual painting. FIG. 7 illustrates the first, white layer of ink laid down on the substrate. As seen in FIG. 7, the white ink is applied more heavily in some areas 701 as compared to others 702, allowing the ink to build up to form an underlying texture for the additional layers. As shown in FIG. 7, the built up texture layers may mimic brush strokes in an actual painting, or may accent certain areas of the final image. FIG. 8 illustrates the application of the second ink layer 800 laid down on the substrate. The second ink layer 800 shown in FIG. 8 is an example of a color texture layer. FIG. 9 show an example of the third ink layer 900, which is made using color print heads. The color print heads may be standard cyan, magenta, yellow, and black print heads. FIG. 10 is an example of the image formed on the substrate during the process of laying down the various layers of ink, and shows the substrate as it would be coming off of the press. As can be seen in FIG. 10, the white ink layer 1000 (first layer) is laid down, followed by the color ink texture layer 1001 (second layer), and lastly the final color ink layer 1002 (third layer).

In other embodiments, the texture may be created by laying down a layer of color or clear ink instead of the white ink layers as described above. The color or clear ink may be applied in a similar shape and area as the white ink described above, allowing the color or clear ink to build up into peaks and valleys, thereby creating dimensions and shapes. When using color inks, more build up may be achieved as more ink can be applied.

The process can be used to create any texture on a substrate in line at the time of print production. As mentioned above, the texture effects achieved through the printing process may include brush strokes, burlap, canvas, matte finish, or embossing. The process may also be used to create a logo or secondary image to be printed under the color image. The underlying ink layers are built up in the pattern of the logo or secondary image, with the color layer then being laid down on top to create the final color image with underlying logo or secondary image. Existing artwork or images may also be used as the substrate printed upon. It may be desired to accent or embellish the existing artwork or image by adding texture or effects to certain areas. As an example, texture patterns and a combination of two color layers may be laid down upon an existing artwork or image to create a matte or semi-gloss look.

When using the canvas texture pattern, the system and methods allow for a flat substrate material to be printed upon, with the final image appearing as if it was printed on a more expensive canvas material. This allows for consumers to obtain a product that closely mimics high quality works printed directly on canvas at a much lower price point. The system and methods can also be used to allow consumers to upload their own images for printing, wherein the finished printed product is created in the form of the more expensive gallery wrap print style. According to some embodiments, the system may contain a database of previously stored images that a customer may select for purchase and display.

To provide a printed product that may be directly displayed without the need to mount the print onto a frame or other backing material, the substrate may contain pre-formed folds or lines indicating where the substrate could be folded. In these embodiments, folding the substrate along the folds or lines transforms the substrate into a form that mimics a canvas print or gallery wrap. When an underlying texture has been applied during the printing process, this final gallery wrap may mimic a more expensive piece of art printed directly upon canvas material. The same effect of mimicking the more expensive canvas gallery wrap may be achieved using the other substrate materials discussed herein. The pre-formed folds or fold lines could also be arranged so that the final image product folds into any two or three-dimensional shape. The substrate with pre-formed folds or fold lines may be made out of a corrugated box material, pressure sensitive vinyl, paper, or any flat, smooth material. Alternatively, the substrate may have some texture already included thereon, wherein the system and methods are used to add additional texture. After printing, the substrate may be folded along the pre-formed folds or fold lines to create the final image product. Tabs may be provided in the substrate form, holding the substrate together after assembly into the final image product.

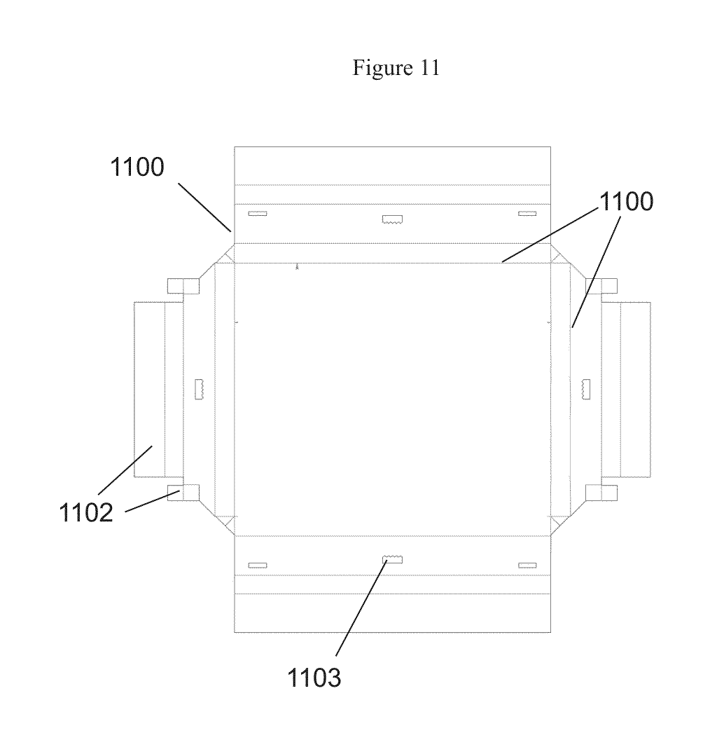

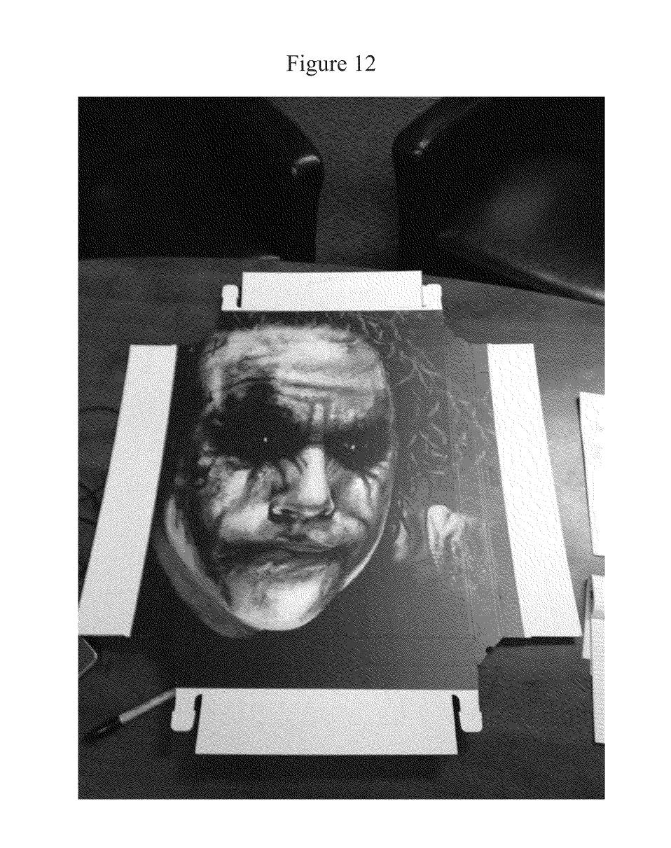

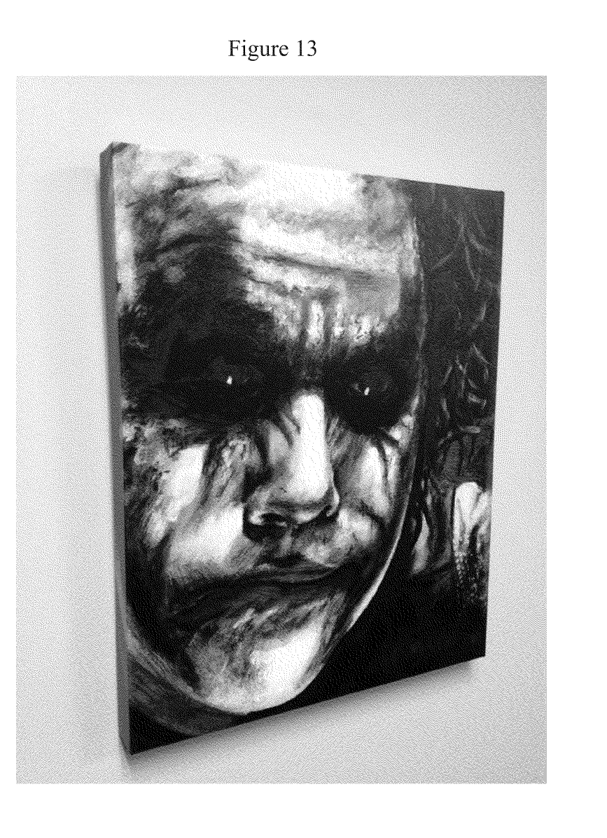

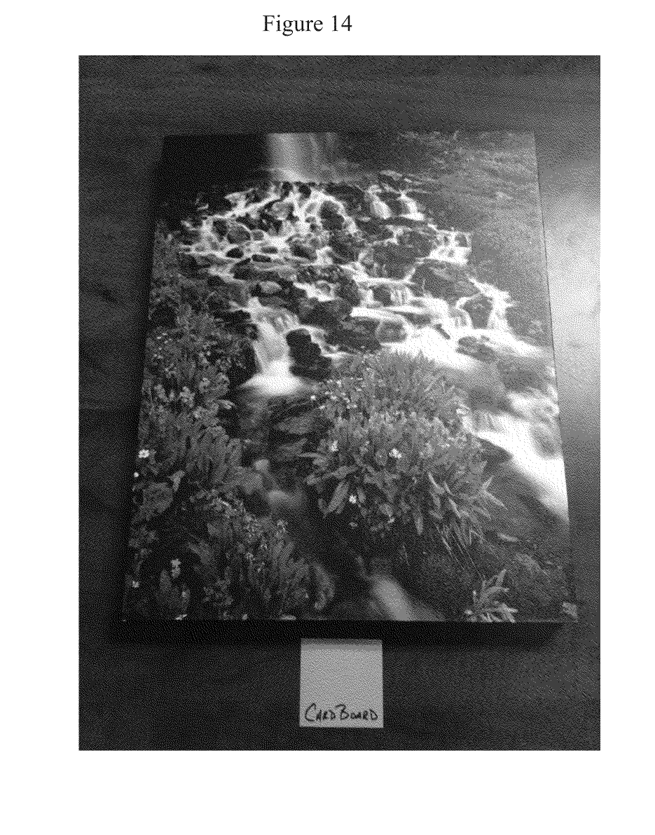

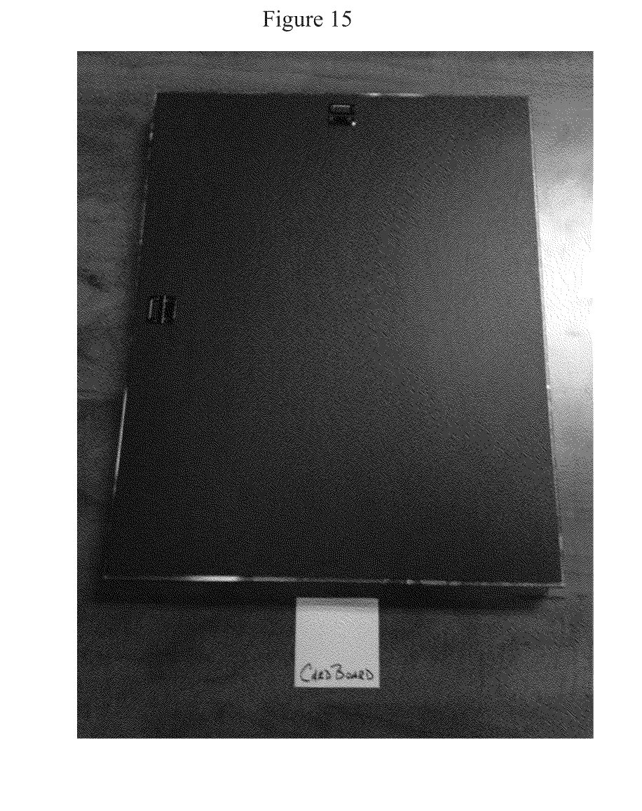

As seen in FIG. 11, the substrate 1100 may be provided in a shape with pre-formed folds or fold lines 1101, as well as tabs 1102 for forming a final image product. The substrate may also include pre-attached fasteners 1103 for hanging the final image product on a wall. Alternatively, pre-formed pieces of the substrate may be created with fold lines to allow the final image product to stand on a table, similar to a picture in a picture frame. FIGS. 12 and 13 show a final image product on a substrate both before and after folding along the pre-formed folds and fold lines to assemble the product. FIGS. 14 and 15 show a front view and a back view of a final image product created from a substrate with pre-formed folds and fold lines. Although FIGS. 14 and 15 show a cardboard substrate, this is for illustrative purposes only and other materials may be used for the substrate.

As mentioned above, the substrate may be made of a corrugated box material, such as cardboard. A die cut of multiple sizes may be used to create the cardboard substrate in a sheet. The die may strike folds or fold lines into the substrate. The sheet may be placed into the printing press, wherein the process described above is implemented to form the image on the substrate. After the various layers of ink have been laid down on the cardboard substrate creating the textured image thereon, the substrate is folded along the die-struck areas to form a final construction of the image product. For example, the substrate may be folded into a final box construction to look like a gallery wrap as seen in FIGS. 14-15. The final construction may be held together by inserting tabs included in the die cut substrate into each corner of the final product. The tabs may be tucked inside the perimeter, and then released to create resistance against the interior of the box formed from the substrate. In this embodiment, no glue, staples, tape or other fasteners are required. In other embodiments, the tabs may be inserted into slots, or may be held in place using glue, tape, staples, or any other fastener. After the substrate is folded into the final product form, a backer material that has been precut to the final size and shape may be attached as shown in FIG. 15. The backer material may have hangers already mounted thereon. The backer may be attached using glue, double sided tape, staples, or any other fastener. Following attachment of the backer material, the resulting image product may be in the form of a gallery wrap with the image printed around all sides, including a finished backer ready for hanging on a wall.

According to another embodiment, the substrate may be formed of a paper material. After printing the textured image on the paper substrate, the paper substrate may be mounted on a mount structure such as a board, foam, or other rigid material formed in the desired shape and dimension of the final product. The paper may be mounted using glue, tape, staples, or any other fastener. By wrapping the paper substrate around a box shape mount structure, the final print image with texture may be in a gallery wrap format.

According to another embodiment, the substrate may be formed from a pressure sensitive vinyl material, including an adhesive layer and a backing layer. Following printing of the textured image on the substrate, the backing layer may be removed to reveal the adhesive layer. The pressure sensitive vinyl substrate may then be mounted on a mount structure such as a board, foam, or other rigid material formed in the desired shape and dimension of the final product. Following attachment to the mount structure, a backing material with pre-attached fasteners for hanging may be attached. When the mount structure is in the form of a box, the final product may be in a gallery wrap form with the image printed on all sides.

1. A system for creation of texture on a substrate by printing with layers of ink, the system comprising:
a. a computer device comprising a memory, user interface, and an image editing module, wherein the image editing module is configured to allow a user to adjust properties of an image and output an adjusted image; and
b. a press configured with at least one printer head; wherein the press is configured to print ink on the substrate in a single pass, while allowing the ink to build up in a pattern to create a desired texture corresponding to the adjusted image.

2. The system of claim 1, wherein the press includes at least one white or clear ink printer head and at least one color ink printer head.

3. The system of claim 2, wherein the white or clear ink printer head is configured to lay down ink such that the ink builds up to create the desired texture and the color ink printer head is configured to lay down ink forming the final image on top of the white or clear ink texture layer.

4. The system of claim 1, wherein the adjusted image comprises at least two image layers.

5. The system of claim 4, wherein at least one of the image layers includes the pattern for the texture to be applied to the substrate.

6. A printed image product containing a textured image thereon comprising:
a. a substrate material containing pre-formed folds or fold lines, wherein folding the substrate along the pre-formed folds or fold lines produces the final shape of the printed image product; and
b. at least one layer of ink, wherein the at least one layer of ink is built up to create a texture on the substrate.

7. The printed image product of claim 6, wherein the substrate further comprises tabs configured to be inserted into the corners of the folded product to hold the product in its final shape.

8. The printed image product of claim 7, wherein the final shape is of a gallery wrap.

9. The printed image product of claim 6, further comprising a backing material having hangers thereon for hanging the printed image product.

10. A method for producing texture on a substrate using inks, the method comprising:
a. providing an image of a desired texture to an image editing module;
b. modifying the properties of the image in the image editing module to create an adjusted texture image having properties corresponding to a desired amount of ink to be printed at least one area of the image of the desired texture;
c. ripping the adjusted texture image to a press, wherein the adjusted image comprises at least one image layer;
d. laying down at least a first layer of ink based on the properties of the adjusted image, wherein the ink is built up to achieve the desired texture on the substrate.

11. The method of claim 10, further comprising providing multiple image layers to the press.

12. The method of claim 11, wherein the multiple image layers include at least one white or clear image layer and at least one color image layer.

13. The method claim 12, wherein the at least one white or clear image layer corresponds to the adjusted texture image for creating the desired texture on the substrate, and wherein the at least one color layer corresponds to a final image on the substrate.

14. The method of claim 10, wherein laying down at least a first layer of ink comprises first laying down a white or clear ink layer to build up the desired texture, and subsequently laying down at least a second layer of ink on top of the white or clear ink layer to form a final image with underlying texture.
